(19) United States
(12) Patent Application Publication
(10) Pub. No.: US 2019/0122573 A1
(43) Pub. Date: Apr. 25, 2019

(54) Educational toy for learning foreign languages

(71) Applicant: Sejean Yang, Fairfax, VA (US)

(72) Inventor: Sejean Yang, Fairfax, VA (US)

(21) Appl. No.: 15/732,292

(22) Filed: Oct. 23, 2017

(51) Int. Cl. G09B 1/08; G09B 19/08; A63H 33/04

(52) U.S. Cl. CPC G09B 1/08; A63H 33/046; G09B 19/08

(57) ABSTRACT

The present invention shows children who are learning about simple sentence structures and noun-verb agreement sample sentences. Furthermore, it helps them see how a singular noun matches with a singular verb, as opposed to a singular noun with a plural verb, which would be incorrect. The product includes two different sets of blocks, which produce different sentences. The subject blocks, on their right end, have either a positively charged or negatively charged magnet, which matches the correct verb. Similarly, the verb blocks have negatively and positively charged on either side. Lastly, the direct object or modifiers blocks have either a positively or negatively charged magnet on the left side. The sentences have been planned out that the blocks that attract together always make sentences that are logical. Within both sets, the nouns are in one container, the verbs in another, and the direct objects or modifiers in another. So, the user can select blocks and test out whether or not they match together.

### FIELD OF THE INVENTION

This invention shows children who are learning about simple sentence structures and noun-verb agreement sample sentences and helps them to see how a singular noun matches with a singular verb, as opposed to a singular noun with a plural verb, which would be incorrect.

### BACKGROUND OF THE INVENTION

In the past, the development of transportation and communication has erased the physical boundaries between all kinds of division, and people are able to meet freely across borders. However, communication between different languages still remains an urgent problem, especially for people wanting to learn English. Foreigners who are not native English speakers endeavor to invest a lot of time and money to develop their English language skills. Naturally, a constantly growing market for learning English (referred to as representing a foreign language, the same applies below) is formed, like private tutoring, language education services, overseas training, and study abroad programs. This general language education is divided into four functions: listening, reading, writing and speaking. Language using characters should accomplish the above four functions evenly. However, grammar is an important foundation for a person who is learning any language.

In an environment where English is learned by many foreigners, especially children, difficulties arise due to differences from the grammar of their respective native languages. For this reason, many English educators have tried to develop creative methods for teaching and to understand their students' perspectives in accordance with cognitive developmental stages and language learning principles.

In the past, the learning models for grammar were mainly based on textbooks. However, there is a limit for this method's effectiveness. Since it is important that a language should be recognized and utilized as naturally as possible, there is a need for a way to understand grammar while learning a foreign language with the best teaching possible. However, conventional grammar education often prevents this type of creative learning of natural grammar by presenting difficult terms and memorization.

For example, grammar education for children ages 2-6 years old is not easy to achieve, unless special measures are taken. The difficult grammar terminology puts stress on learning for children, especially when English is not their native language. In addition, excessive knowledge transfer does not help children's emotional development. Therefore, in the actual educational environment, grammar tends to learn memorization rather than true learning.

In order to fundamentally solve the problem of conventional grammar education, grammar education should be fun and focus on different, creative learning techniques for all children. One effective method involving toys helps children grasp the context of grammatical rules naturally. The inventor of the present invention has made a long effort to accomplish this purpose and finally completed the present invention.

### BRIEF SUMMARY OF THE INVENTION

The present invention provides a novel grammar education tool which enables English learners to learn foreign grammar with ease and familiarity. Another objective of the present invention is to add a creative and fun element in grammar education. Specifically, the magnet is an example of traditional and most effective toy for all ages. This is based on the concept that assembling specially designed blocks is like making connections in the brain.

This also scientifically models various linguistic rules related to the sentence structure by implementing them in a toy model. Other objectives of the invention which are not explicitly stated will be further considered within the scope of the following detailed description and easily deduced from the effect thereof.

In order to achieve the objectives listed above, the invention provides an English-learning toy, comprising of a set of subject word magnetic blocks of which right end are charged with a first polarity; a set of verb word magnetic blocks of which left end are charged with a second polarity, that is opposed to the first polarity, while right end are charged with the first polarity; and, a set of direct object or modifier blocks which are not charged, wherein the subject word magnetic blocks are classified into singular noun and plural noun, and so are the verb word magnetic blocks, a user can select magnetic blocks and test out whether or not they match together.

Preferably, the subject word magnetic blocks, the verb word magnetic blocks, and the direct object or modifier blocks are arranged and fitted without any margin in a wooden frame.

According to the present invention, a user who wants to learn English can learn the relationship between a singular/plural noun and singular/plural verb through kinesthetic learning methods making it much more effective than simply studying only through reading. By seeing the magnets connect or repel, the user will have these images and ideas implemented in their minds. Even if effects not specifically mentioned in the specification of the present invention are incorporated herein, the provisional effects expected by the technical features of the present invention are considered as described in the specification of the present invention.

### BRIEF DESCRIPTIONS OF THE DRAWINGS

FIG. 1 is a diagram illustrating the principle of the present invention by showing the combination of a subject word magnet block, a verb word block and a direct object or modifier block according to the present invention.

FIG. 2 is a diagram showing an example of the configuration of a grammar box in which the magnet blocks and are arranged and fitted without any margin in a wooden frame according to an embodiment of the present invention.

FIG. 3 is a table showing examples of the grammatical relationships which are used in the education toy for learning foreign languages according to an embodiment of the present invention.

### DETAILED DESCRIPTION OF THE INVENTION

English sentences have four components: subject, verb, object, and modifier. These sentence patterns are learned to analyze and complete English sentences through parts of speech classified by detailed grammatical elements such as nouns, articles, pronouns, adjectives, auxiliary verbs, prepositions, infinitives, gerunds, relative pronouns, and related adverbs. From the point of view of system design method in the field of computer engineering, it can be called top-down method. This method is a scheme in which a structure as a whole is first planned, and then a detailed design is performed in detail. In other words, the conventional method of teaching English grammar adopts the characteristic of inscribing the structure of “English law” in the head of the students. This structure is time-consuming, uninteresting, and ineffective because it has to be artificially injected into students' minds.

The present invention is directed to a bottom-up method. According to the bottom-up model of the present invention, the learners can learn the English grammar naturally by attempting to construct a sentence by using “word” and “grammar”. It is like the process of learning the structure of English grammar in a real way, and the structure of English grammar is recognized naturally and injected into the mind of students.

The existing English grammar teaching method teach English grammar through various textbooks and teaching methods, but the present invention make children to learn English grammar based on “hand-thinking”. According to the present invention, “word” and “grammar” are combined by hand, and by repeating this combination, the grammatical context is learned. A self-directed learning model in which the learners self-study while assembling themselves by hand and assembling themselves is the technical idea of the present invention.

On the basis of such a concept, a detailed description will be given below for the implementation of the present invention with reference to the accompanying drawings. In the following description of the present invention, a detailed description of known functions and configurations incorporated herein will be omitted when it may obscure the subject matter of the present invention.

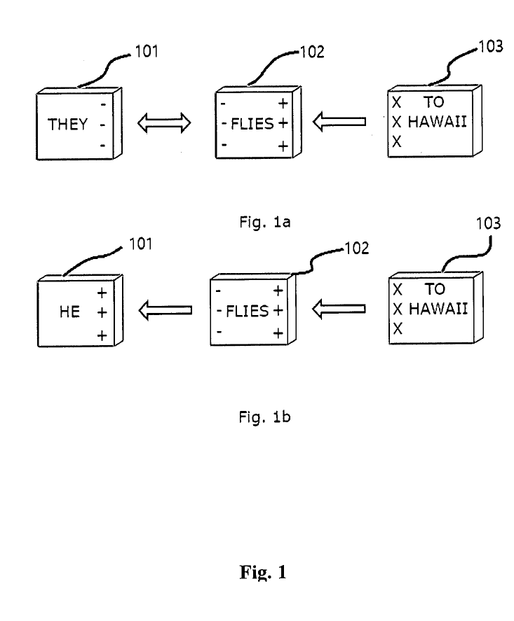

FIG. 1 is a diagram illustrating the principle of the present invention by showing the relationship based on magnetic forces of a subject word magnet block, a verb word block and a direct object or modifier block according to the present invention. The subject word magnetic block, the verb word magnetic block and the direct object or modifier block shown on the drawings are in the shape of cuboids, and made of metals. Especially, subject word magnet blocks and verb word blocks are magnetic.

The subject word magnetic block, the verb word magnetic block and the direct object or modifier block shown on the drawings are ones of respective block groups of a subject words, verb words and direct object or modifier group.

The set of subject word magnetic blocks are composed of nouns, pronouns, proper nouns including name or places. Furthermore, the nouns or pronouns are classified by plural nouns and singular nouns. Similarly, the set of verb word magnetic blocks are composed of verbs and classified by plural verbs and singular verbs.

The set of the direct object or modifier blocks are composed of nouns, objective pronouns, for example, me, him, them or her, and other words which can be a modifier or modifiers, for example, adverbs, adjectives and nouns.

The right end of subject word magnetic blocks are charged with a first polarity, namely, one of positive (+) or negative (−), and the left end of verb word magnetic blocks are charged with a second polarity, that is opposed to the first polarity. While, the right end of verb word magnetic blocks are charged with the first polarity, i.e., the polarity of the right end of subject word magnetic blocks. On the other hand, the set of direct object or modifier blocks are not charged by the first polarity or the second polarity.

Therefore, as can be seen from FIG. 1a, if a user brings a verb word magnetic block 102, on which a singular verb “FLIES” is written, closer to a subject word magnetic block 101, on which a plural pronoun “THEY” is written, both magnetic block 101, 102 repulse each other by the repulsion force of same polarity, thus it is impossible to put together. However, if the user brings the same block 102, on which a singular verb “FLIES” is written, closer to the subject word magnetic block 101 on which a singular pronoun “HE,” both magnetic block attract each by the attraction force of different polarity, and stick together.

While the ends of the subject word magnetic block 101 and the verb word magnetic block 102 are charged, the direct object or modifier blocks do not need to be charged because they have no singular-plural concordance in English grammar.

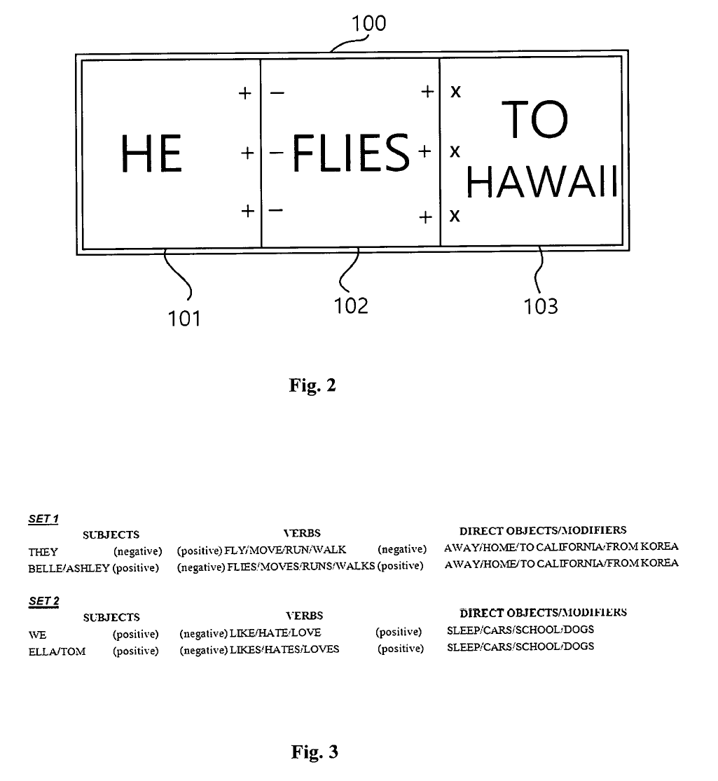

FIG. 2 is a diagram showing an example of the configuration of a grammar box in which the magnet blocks and are arranged and fitted in a wooden frame 103. According to the educational toy of the present invention, a user, typically a child at the age of less than 3, can learn the relationship between a singular/plural noun and singular/plural verb, and it helps them see how a singular noun matches with a singular verb, as opposed to a singular noun with a plural verb, which would be incorrect.

FIG. 3 is a table showing examples of the grammatical relationships between which are used in the education toy for learning foreign languages according to an embodiment of the present invention. A child can select blocks and test out whether or not they match together. For example, if a child picks a singular noun and a plural verb, then the blocks will pull away from each other because the blocks would have the same polarity. This helps implement the idea that a singular noun does not match with a plural verb or vice versa. When the child matches the blocks correctly, the blocks will stick together, and the child will be able to remember and make the connection of the proper conjugations and agreements within sentences.

The above embodiments of the present invention mainly describe for English as a foreign language. However, this was only for a consistent and logical explanation. Not only English, but also foreign languages with grammatical rules will be included here. Therefore, the protection scope of the present invention shall not be limited only by English.

1. An educational toy, comprising: a set of subject word magnetic blocks of which right end are charged with a first polarity; a set of verb word magnetic blocks of which left end are charged with a second polarity, that is opposed to the first polarity, while right end are charged with the first polarity; and, a set of direct object or modifier blocks which are not charged, wherein the subject word magnetic blocks are classified into singular noun and plural noun, and so are the verb word magnetic blocks, a user can select magnetic blocks and test out whether or not they match together.

2. The educational toy according to claim 1, the subject word magnetic blocks, the verb word magnetic blocks, and the direct object or modifier blocks are arranged and fitted without any margin in a wooden frame.

3. The educational toy according to claim 1, the subject word magnetic blocks are in one container, the verb word magnetic blocks are in another, and the direct objects or modifiers in another.
